(19) United States
(12) Patent Application Publication
(10) Pub. No.: US 2009/0011886 A1
(43) Pub. Date: Jan. 8, 2009

(54) Method And Apparatus For Operating A Transmission Oil Pump

(76) Inventor: Andreas Schondelmaier, Erdmannshausen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/793,150

(22) PCT Filed: Nov. 29, 2005
(86) PCT No.: PCT/EP05/12740

§ 371 Date: Sep. 26, 2008

(30) Foreign Application Priority Data
Dec. 18, 2004 (DE) 10 2004 061 034.7

(51) Int. Cl. F16H 57/04; G06F 17/00

(52) U.S. Cl. 475/5; 701/51

(57) ABSTRACT

The invention relates to a method for monitoring the function of a motor-vehicle transmission oil pump (3) which is driven by an electric motor (4) in accordance with an electronic power system (11), and a device for operating a transmission oil pump (3) of a motor vehicle, having an electric motor (4) as a main drive of the transmission oil pump (3) and an electronic power system (11) which is assigned to the electric motor (4), wherein the transmission oil pump (3) can be connected to at least one backup drive (1, 7, 8).

The object of the invention is to increase the availability and reliability of a transmission oil pump (3).

This object is achieved in that a monitoring unit (12) monitors the function of the transmission oil pump (3) and activates a backup drive (1, 7, 8) if a fault is detected. For this purpose a monitoring unit (12) is provided for monitoring the function of the transmission oil pump (3).

The invention relates to a method according to the preamble of claim 1 and a device according to the preamble of claim 6.

DE 103 10 594 A1 discloses a drive power open-loop/closed-loop control device for a hybrid vehicle, having an internal combustion engine and a motor generator as drive sources.

DE 103 09 846 A1 discloses an open-loop and closed-loop control device for a vehicle, having a transmission which is connected to an internal combustion engine via a drive shaft so that a transmission ratio between them can be changed, wherein the drive force of the internal combustion engine is transmitted to the driven wheels via a drive shaft. An oil pump is driven by the internal combustion engine. A motor-operated oil pump, which is driven by supplying electric current, is provided independently of this oil pump. The open-loop/closed-loop control device contains a closed-loop control system which performs closed-loop control of the motor-operated oil pump which makes available the oil pressure for the closed-loop controllable activation of the automatic transmission when the internal combustion engine stops or starts. If the oil pump which is driven by the internal combustion engine can not operate because the internal combustion engine stops, the motor-operated oil pump takes over.

The genus-forming document DE 199 23 154 A1 discloses a dual pump drive in which an oil pump is connected to an electric motor by means of one free wheel and to a drive train by means of another free wheel. As a result, the oil pump is driven as a function of the rotational speed either of the electric motor or of the drive train. A control device is provided which can be used to switch the electric motor on and off.

The object of the invention is to increase the availability and reliability of a transmission oil pump.

This object is achieved by means of a method having the features of claim 1 and a device having the features of claim 6.

The method according to the invention for monitoring the function of an electrically driven transmission oil pump of a motor vehicle is defined by the fact that a monitoring unit monitors the function of the transmission oil pump and activates a backup drive if a fault is detected. As a result, even if the main drive of the transmission oil pump fails the satisfactory operation of this transmission oil pump is ensured.

Transmission oil pumps, for example crescent-type pumps, are so simple and robust in terms of construction that mechanical defects are virtually excluded. If a fault occurs in a transmission oil pump, the cause therefore has to be looked for in the drive of the transmission oil pump. If a defect is detected in the function of the transmission oil pump, it can consequently be eliminated by operating the transmission oil pump with a backup drive. The availability of the transmission oil pump is thus increased and the probability of a failure of the transmission oil pump is significantly reduced.

In one embodiment of the method, the monitoring unit triggers a fault reaction of the electric motor if an electronic power system of the electric motor of the transmission oil pump does not operate satisfactorily. A fault in the electronic power system can result, for example, from incorrect data transmission. The electric motor is switched off as a possible fault reaction so that a backup drive can take over the function of driving the transmission oil pump. Depending on the type and duration of the incorrect data transmission, a possible reaction of the electric motor may be to behave as if the last correctly transmitted control data continue to be valid without modification.

This prevents incorrect information from the electronic power system from leading to an incorrect reaction by the electric motor, or to a situation in which there is no reaction to a failure of the electronic power system.

In one embodiment of the method, the power drain of the electric motor of the transmission oil pump is monitored and the actual state of the electric motor of the transmission oil pump is determined therefrom. For example, the power drain is sensed by means of current sensors of the electronic power system. It is thus possible to determine the actual state of the transmission oil pump without additional sensors by means of the data which is already present.

In one embodiment of the method, in the event of a fault the power supply of the electric motor of the transmission oil pump is switched off. In this context the power supply is composed, for example, of an HV supply and of a 12 V supply. The power supply can, for example, be interrupted at a safety fuse. This ensures that despite a short circuit or a fault in the electronic power system the electric motor does not continue to be operated. This prevents a fault having an adverse effect on the transmission. In this context, the switch off path is preferably configured in such a way that no damage can occur (failsafe). For example, the hydraulic system is embodied in such a way that unacceptable valve positions of the control valves are already impossible owing to the hydraulic connections. In the event of a fault, the system inevitably goes automatically into a safe and nonhazardous state.

In one alternative embodiment, the electric motor (4) can be switched off by actively triggering a short circuit in the electronic power system (11). Here too it is ensured that despite a short circuit or a fault in the electronic power system the electric motor does not continue to be operated. This prevents a fault having an adverse effect on the transmission.

In one embodiment of the method, in the event of a fault all the operating modes of the transmission which require a stationary backup drive of the transmission oil pump for their implementation are disabled and the switching strategy of the transmission is adapted to the changed selection of operating modes. This prevents an operating mode being switched on which can no longer be operated satisfactorily. The rotation speed of the backup drive is matched to the requirements of the transmission oil pump. In this way the transmission oil pump is fully effective again.

The device according to the invention for operating a transmission oil pump of a motor vehicle, having an electric motor as the main drive of the transmission oil pump and an electronic power system which is assigned to the electric motor and in which the transmission oil pump can be connected to at least one backup drive, is defined by the fact that a monitoring unit is provided for monitoring the function of the transmission oil pump. In the event of a failure of the main drive, the transmission oil pump can be operated by means of a backup drive. In this context, the backup drive assumes the function of the main drive. As a result, even in the event of a failure of the main drive, satisfactory operation of the transmission oil pump is ensured. The selection of a main drive which is independent of the internal combustion engine makes it possible to provide all the operating modes of the transmission by means of the device without a further transmission oil pump. In this context, the pumping capacity of the transmission oil pump which can be provided is independent of the operating mode of the transmission.

A monitoring unit is provided for monitoring the function of the transmission oil pump. This ensures that any fault in the function of the transmission oil pump is detected immediately. An advantage of a separate monitoring unit is that the results of the electronic power system can be checked and ensured independently by means of external variables. The functional monitoring of the transmission oil pump by a monitoring unit which is independent of the electronic power system significantly reduces the probability of failure of the transmission oil pump. Compared to a solution with two transmission oil pumps, there is a saving in terms of the cost of a second transmission oil pump while the safety of the system is comparable.

The monitoring unit is preferably arranged in a transmission controller. This has the advantage that the monitoring unit can directly access the information of the transmission controller without long transmission paths. A further advantage is that the monitoring unit is arranged separately from the electronic power system. This spatial separation has the advantage that external disruption (for example heat, cold, dirt) which disrupts the function of the electronic power system does not necessarily act also on the monitoring unit. The physical separation (no commonly used memories etc.) has the advantage that a fault in the electronic power system does not lead to faults in the monitoring unit. In this context, as a result of the integration of the monitoring unit into the transmission controller there is a saving in terms of the cost of a separate component which would only contain the monitoring unit.

In one embodiment of the device, a backup drive is an internal combustion engine. This has the advantage that the backup motor is already present on a series manufactured basis. In the case of a hybrid drive, the selection of the internal combustion engine as a backup drive has the advantage that all the transmission settings are possible and only the start/stop operating mode (and in certain hybrid concepts the pure electric driving mode) have to be deactivated.

In one embodiment of the device, a backup drive is an additional electric motor. Such a motor is already present on a series manufactured basis in a hybrid vehicle.

Further features and feature combinations result from the description and the drawing. In the text which follows, the invention will be presented with reference to the drawing and described in more detail in the following description.

In said drawing:

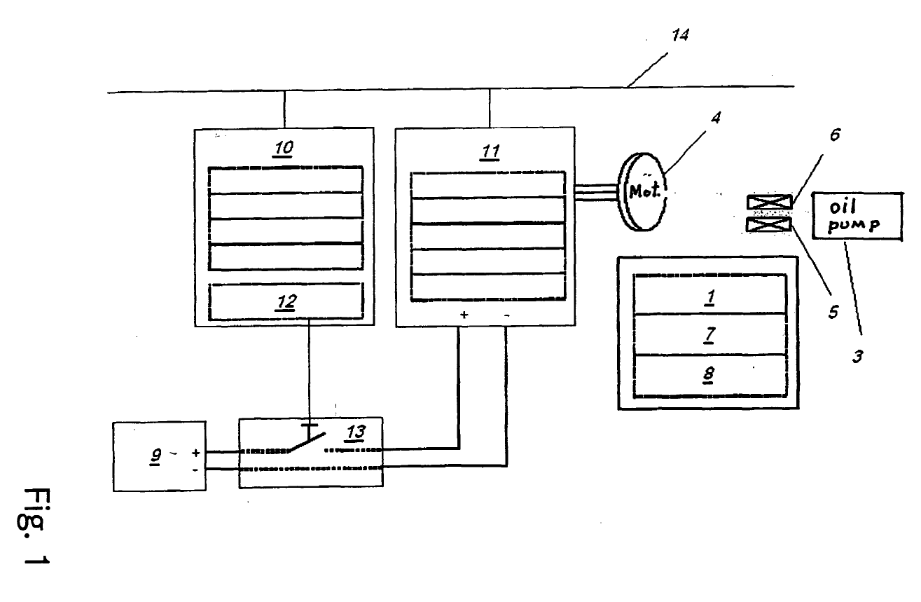

FIG. 1 is a schematic design of an embodiment of the device according to the invention.

FIG. 1 shows an embodiment of a device according to the invention for operating a transmission oil pump 3 of a motor vehicle. The transmission oil pump 3 can be connected mechanically to an electric motor 4 via a free wheel 6. The electric motor 4 is connected to a battery 9 via an electronic power system 11. A fuse 13 can be provided between the battery 9 and the electronic power system 11.

The battery 9 supplies the electronic power system 11 of the electric motor 4 with current. The electronic power system 11 carries out self-monitoring. In this context it is checked, for example, whether the content of an internal memory is appropriate or whether messages are transmitted correctly. Furthermore, the electronic power system 11 carries out functional monitoring of sensors (for example oil pressure sensors, temperature sensors) and actuators (hydraulic valves, clutches of the transmission etc.). The electronic power system 11 monitors parameters of power output stages with the objective of finding faults such as a short circuit or a break in a circuit and reacting thereto. The electronic power system 11 supplies the electric motor 4 with current and controls and monitors its function. It carries out power balancing of the electric motor 4 by sensing the power drain of the electric motor 4 by means of current sensors. As a result, the actual state of the electric motor 4 can be sensed and monitored.

The electric motor 4 serves as a main drive of the transmission oil pump 3. It can be embodied, for example, as a permanent energy synchronous machine. The electric motor 4 drives the transmission oil pump 3 in accordance with the electronic power system 11.

The electronic power system 11 and the electric motor 4 are monitored in terms of their function by a monitoring unit 12. This monitoring unit 12 constitutes a redundant monitoring level which is independent of the electronic power system 11. For this purpose, the transmission oil pressure is sensed and the power drain and the rotational speed of the electric motor 4 are determined (for example from the phase currents without sensors). The received data is checked for plausibility. The monitoring unit 12 is able to monitor the backup drive 1, 7, 8 when there is a changeover to a backup drive 1, 7, 8. In this context, the electronic power system of the backup drive 1, 7, 8 can also be monitored by the monitoring unit 12.

In the embodiment illustrated in FIG. 1, the monitoring unit 12 is arranged in a transmission controller 10. In this context, the monitoring unit 12 receives data from the electronic power system 11 and from the transmission controller 10. For this purpose the electronic power system 11, the monitoring unit 12 and the transmission controller 10 are connected to one another via a data network 14.

As is illustrated in FIG. 1, the transmission oil pump 3 can be connected to one or more backup drives 1, 7, 8 via a free wheel 5 or the like. The drive can thus be changed quickly and easily. When there is a free wheel 5, the transmission oil pump 3 is always driven by the most quickly rotating of the drives 4, 1, 7, 8 which are connected to it.

Mechanical connections are also conceivable between the transmission oil pump 3 and the drives 4, 1, 7, 8, said connections permitting the transmission oil pump 3 to be driven jointly by a plurality of drives 4, 1, 7, 8.

The backup drives 1, 7, 8 are, for example, the internal combustion engine 1 of the motor vehicle and a first electric motor 7 and a second electric motor 8 of a hybrid drive of the motor vehicle.

If the monitoring unit 12 detects a fault in the electronic power system 11 or the electric motor 4, the drive of the transmission oil pump 3 is switched over from the electric motor 4 to a backup drive 1, 7 or 8. For this purpose, the power supply 9 of the electronic power system 11 is switched off. The transmission controller 10 disables all the operating modes of the transmission 2 (not illustrated in FIG. 1) at which the backup drive 1, 7 or 8 which is now selected has to be inactive.

Examples of such operating modes are electric driving or the automatic start/stop function of the internal combustion engine 1. If appropriate, the transmission switching strategy is correspondingly adapted. The selected backup drive 1, 7 or 8 is actuated in such a way that the transmission oil pump 3 operates as desired. This may signify, for example, increasing the idle motion of the internal combustion engine 1.

1.-9. (canceled)

10. A method for operating a motor-vehicle transmission oil pump which is driven by an electric motor in response to an electronic power system, said method comprising:
a monitoring unit monitoring functioning of the transmission oil pump; and
said monitoring unit activating a backup drive if a fault is detected.

11. The method as claimed in claim 10, wherein the monitoring unit triggers a fault reaction of the electric motor if an electronic power system of the electric motor of the transmission oil pump malfunctions.

12. The method as claimed in claim 10, wherein:
the power drain of the electric motor of the transmission oil pump is monitored; and
the actual state of the electric motor of the transmission oil pump is determined therefrom.

13. The method as claimed in claim 10, wherein in the event of a failure, the power supply to the electric motor of the transmission oil pump is switched off.

14. The method as claimed in claim 10, wherein in the event of a failure:
all operating modes of the transmission which require a stationary backup drive for the transmission oil pump are disabled;
switching strategy of the transmission is adapted to a changed selection of operating modes; and
rotational speed of the backup drive is matched to meet requirements of the transmission oil pump.

15. A device for operating a transmission oil pump of a motor vehicle, comprising:
an electric motor as a main drive of the transmission oil pump; and
an electronic power system which is assigned to the electric motor; wherein
the transmission oil pump can be connected to at least one backup drive; and
a monitoring unit monitors functioning of the transmission oil pump.

16. The device as claimed in claim 15, wherein the monitoring unit is arranged in a transmission controller.

17. The device as claimed in claim 15, wherein the backup drive comprises an internal combustion engine.

18. The device as claimed in claim 15, wherein the backup drive comprises an additional electric motor.
